(19) United States
(12) Patent Application Publication
(10) Pub. No.: US 2012/0136766 A1
(43) Pub. Date: May 31, 2012

(54) Electronic Centralized Margin Management System For Managing Actions Such As Margin Recalls Under Margin Agreements

(75) Inventor: Danny Moyse, Marshfield, MA (US)

(73) Assignee: AcadiaSoft, Inc., Pembroke, MA (US)

(21) Appl. No.: 13/272,625

(22) Filed: Oct. 13, 2011

Related U.S. Application Data
(60) Provisional application No. 61/393,676, filed on Oct. 15, 2010.
(60) Provisional application No. 61/393,686, filed on Oct. 15, 2010.
(60) Provisional application No. 61/393,701, filed on Oct. 15, 2010.
(60) Provisional application No. 61/393,710, filed on Oct. 15, 2010.
(60) Provisional application No. 61/393,718, filed on Oct. 15, 2010.
(60) Provisional application No. 61/410,419, filed on Nov. 24, 2010.

(51) Int. Cl. G06Q 40/06

(52) U.S. Cl. 705/35

(57) ABSTRACT

A communications system and method for storing records of registered margin agreements are described. The system and method facilitate processing of a recall of collateral requested from one authorized computer, identified as a request originator, to another authorized computer, identified as a request receiver, over a wide area network. The system includes at least one intermediate computerized system connected to send and receive communications to each authorized computer. The intermediate system is configured to receive, from an authorized computer associated with the request originator, a recall request of collateral established in an account under a registered margin agreement, forward a notification of the recall request to an authorized computer associated with the request receiver identified as a counterparty to the registered margin agreement, receive a response from the request receiver including whether it agrees or disputes the recall, and forward the response from the request receiver to the request originator.

### RELATED APPLICATIONS

The application is based on and claims priority from U.S. Provisional Patent Application Ser. Nos. 61/393,676, 61/393,686, 61/393,701, 61/393,710 and 61/393,718, all filed on Oct. 15, 2010; and U.S. Provisional Application Ser. No. 61/410,419 filed on Nov. 24, 2010, all in the name of Danny Moyse.

### FIELD

The subject technology relates in general to margin management systems, and more particularly to electronic, centralized margin management systems for managing collateral between and among parties to financial instruments such as derivative contracts.

### BACKGROUND

Collateralization is a means of mitigating credit risk associated with privately negotiated financial transactions, such as derivatives. One party posts collateral, such as property, securities, or cash, to mitigate a counterparty's exposure to risk that the collateralizing party will default in performing its obligations under a financial instrument. The financial agreement between the parties outlines the operating procedures for collateralization under, for example, the terms of a margin agreement, such as those types of agreements under the guidelines of the International Swaps and Derivatives Association, Inc. (“ISDA”).

In the case of derivative trades, the parties are typically broker-dealer arms of a banking institution (“sell side”) and professional investment advisors, such as hedge funds and mutual funds (“buy side”). The parties to a derivatives trade maybe a sell side and a buy side firm, or two sell side firms. A derivative is a financial instrument whose value is determined by the value of an underlying index. Examples of derivatives include swaps, futures, and options. Essentially, a party, which may be either buy side or sell side, enters into a derivative agreement to mitigate against a particular exposure to some risk. When the agreement is executed, one side typically posts collateral, and the two sides of the trade are presumably then at a par value. Thereafter, due to daily fluctuations in the value of the underlying index, one party may become more exposed to a greater risk due to decline in the value of the underlying index, requiring the other party to increase the collateral holdings to bring it to par once again. Alternatively, where the daily fluctuations of the index increase the value of the underlying collateral, some reduction in the amount of collateral is desirable for the party posting the collateral, again bringing the collateral holdings to a par. The terms for making these adjustments are governed by a margin agreement, for example a Credit Support Annex (“CSA”) to an ISDA agreement, executed by the parties.

Because exposure and collateral value vary day-to-day, all trades and collateral are marked to market periodically, and oftentimes daily. For example, each morning a party determines the closing market prices from the night before and determines the value(s) of the collateral associated with those closing prices as compared to the value of the collateral originally pledged to determine whether the value of the collateral held needs to be adjusted. The determination of whether the value of the collateral needs to be adjusted is also affected by the provisions of the CSA, which may provide, for example, for a predetermined amount of variance from the pledged value without requiring an adjustment (e.g., the CSA may provide that securities may be as little as 95% of market value of the originally pledged collateral in order to eliminate the need for accommodating small fluctuations in market value). This net allowable difference between the current market value of the posted collateral and originally pledged value is the “margin variation.” A determination is then made as to whether additional collateral will need to be posted (when the market value decreases) or whether the posted collateral can be reduced (when the market value increases). In either of those events adjustment in the posted collateral results in some collateral assets being requested by one counterparty of CSA from the other counterparty of the CSA (known as a “margin call”). This process is called a “compliance check” to verify compliance with the requirements of the CSA. These compliance checks demand that each party have teams of people calculating margin variation and making/receiving margin calls, keeping track of and following up, if necessary, on various transactions.

Operationally, the industry association ISDA (International Swaps and Derivatives Association) has come up with standard provisions for a CSA. The standard provisions cover most contingencies. The standard provisions also define the framework for how the parties operate under the agreement, including how trades are executed between the two parties and what types of collateral one is required to pledge. The agreement might also require that all margin calls be in a specific currency, etc.

Once the trades and collateral are marked to market, each party then communicates with the other, typically via e-mail, regarding the proper collateralization for their agreement, such as making a margin call. In the simplest case, the other party may agree with the amount proposed in the margin call. Once the amount is agreed, the party that is required to make a transfer places the “agreed amount” in a custodial account for the benefit of (“FBO”) the other counterparty.

But often there is a dispute—the party receiving the margin call disputes the final transfer amount proposed in the call (“disputed amount”). The parties often disagree as to the amount necessary to bring the collateralized account into compliance (and sometimes even which party is required to transfer assets), and must resolve those disputes. In this instance, when there is agreement that one party needs to transfer assets, but it is only the amount in dispute, the agreed amount is transferred, with the balance remaining in dispute. The dispute may occur for a number of reasons. For example, the parties may have used different pricing sources in their daily marking to market. Or it could be that one party may have forgotten to book a trade. Or one party may have failed to deliver a prior collateral pledge. Regardless of the reason, this discrepancy in calculation leads to additional back-and-forth between the parties, and may require a third party to reconcile the dispute and achieve proper collateralization.

For example, if one party originates a margin call for $10 M, but the receiving party calculates an amount of only $8 M in its daily marking to market, the parties would settle on the $8 M as an agreed amount, and resolve the remaining $2 M in dispute by sending the portfolios to a third party for reconciliation.

The numbers and calculations are cumbersome, and the communications in managing collateral are inefficient and often difficult for the parties to track. The process mostly relies on standard e-mail messaging. The audit trail is disorganized and not uniform. There is also no way to quickly evaluate the aggregate exposure of a fund or bank, or to audit a certain day's margin management activities. The industry as a whole is looking for ways to automate the process. Even determining which agreement is the subject of a particular communication is challenging because trading groups have their own nomenclature for their agreements, which is likely different from the name of the master agreement and the shorthand used by the other party. Indeed, auditing the transactions underlying an agreement or daily activities of a party can be a logistical nightmare, and considering that the amounts in question are often very large, the consequences for the financial stability of the parties can be quite significant.

### SUMMARY

In accordance with one aspect of the disclosure a system facilitates the processing of a recall of collateral requested from one authorized computer of one party to a registered margin agreement, and identified as the request originator, over a wide area network to another authorized computer of the counterparty to the registered margin agreement, and identified as the request receiver. The system comprises: at least one intermediate computerized system connected so as to send and receive communications over the wide area network to each authorized computer, the intermediate computerized system being configured and arranged so as to (a) receive, from an authorized computer associated with the request originator, a request for recall of collateral established in an account under a registered margin agreement, the recall request comprising recall information, including identification of the margin agreement, and the amount of the requested recall; (b) forward a notification of the recall request over the wide area network to an authorized computer associated with the request receiver identified as a counterparty to the registered margin agreement; (c) receive a response from the request receiver including whether it agrees or disputes the recall; and (d) forward the response from the request receiver to the request originator.

In accordance with another aspect of the disclosure a method facilitates the processing of a recall of collateral requested from one authorized computer of one party to a margin agreement registered on a intermediate computerized system, and identified as the request originator, over a wide area network to another authorized computer of the counterparty to the registered margin agreement identified as the request receiver. The method comprises: at the intermediate computerized system performing the following steps: sending and receiving communications over the wide area network to each authorized computer, including:

(a) receiving from an authorized computer associated with the request originator, a request for recall of collateral under a registered margin agreement, the recall request comprising recall information including identification of the margin agreement, and the amount of the requested collateral being recalled,

(b) forwarding a notification of the recall request over the wide area network to an authorized computer associated with the request receiver identified as a counterparty to the registered margin agreement;

(c) receiving a response from the request receiver including whether it agrees or disputes the recall; and

(d) forwarding the response from the request receiver to the request originator.

The advantages and novel features are set forth in part in the description which follows, and in part will become apparent to those skilled in the art upon examination of the following description and the accompanying drawings, or may be learned by production or operation of the examples. The advantages of the present teachings may be realized and attained by practice or use of the methodologies, instrumentalities and combinations described herein.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a block diagram illustrating one embodiment of an electronic, centralized margin management system;

FIG. 2-3 are examples of screen shots of a portal for creating a file for a margin agreement in the centralized margin management system, such as the one shown in FIG. 1;

FIGS. 4 is an example of a screen shot of an agreement portal for managing those agreements to which an authorized user has access, and operations under those agreements;

FIGS. 5 is an example of a screen shot of a messaging portal for sending messages under the agreements to which an authorized user has access;

FIG. 6 is an example of a screen shot for creating a margin call under one of the agreements to which an authorized user has access;

FIG. 7 is a flow diagram illustrating an example of a margin call in an electronic, centralized margin management system;

FIG. 8 is a flow diagram illustrating an example of a recall in an electronic, centralized margin management system; and

FIG. 9 is a flow diagram illustrating an example of a substitution in an electronic, centralized margin management system.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

The systems and methods disclosed herein are for electronic, centralized margin management systems. Various embodiments of these systems and methods permit the parties to a margin agreement to efficiently make margin calls and other margin management actions through a centralized system.

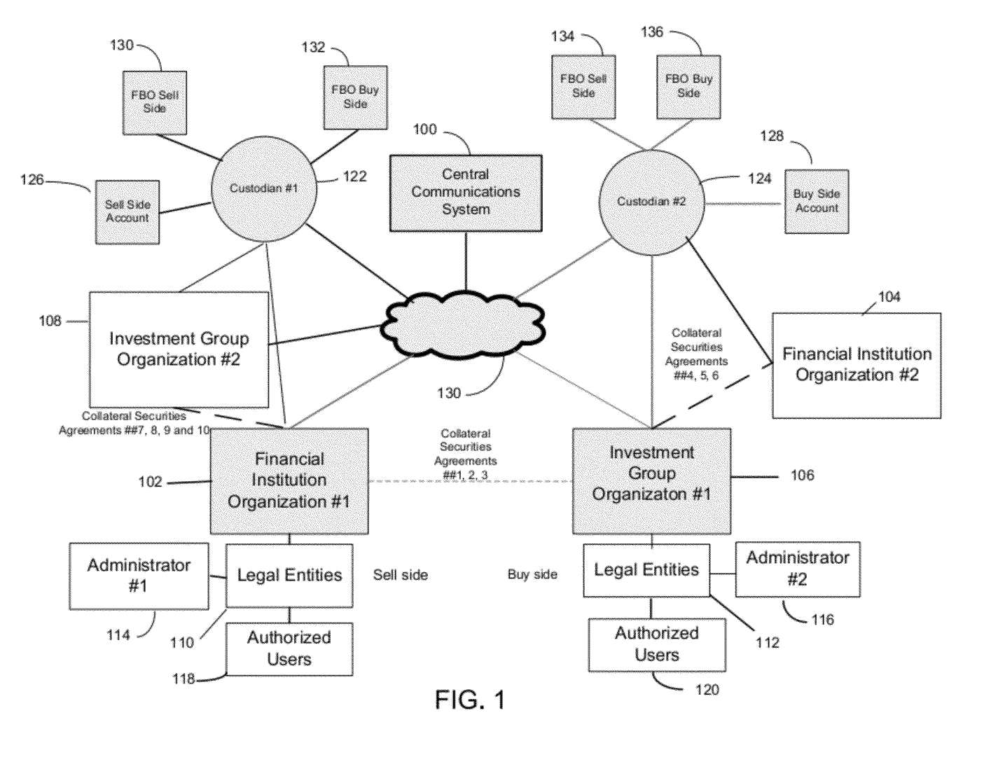

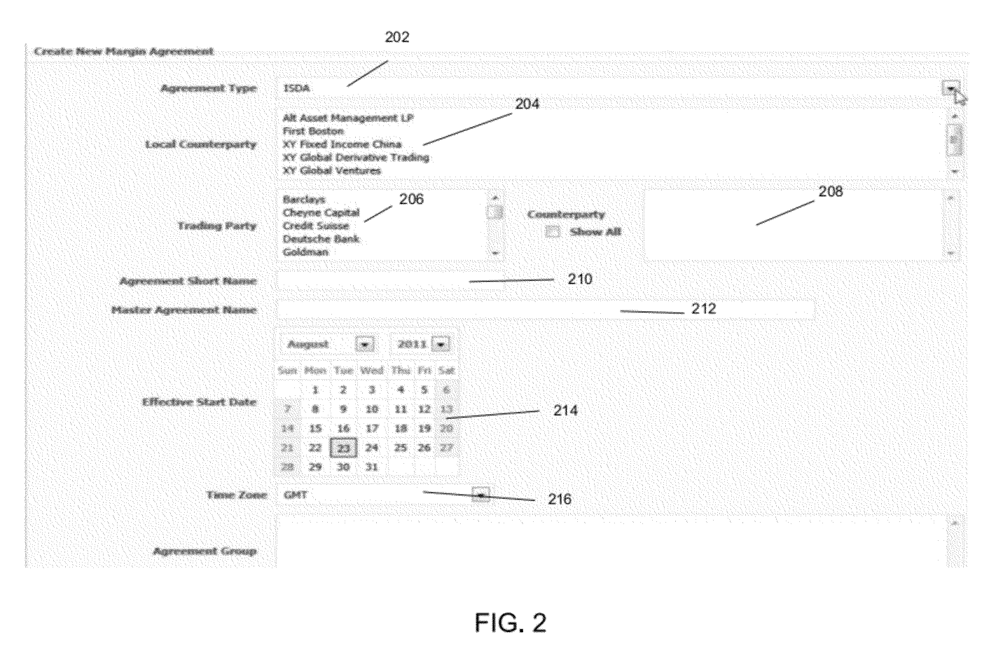

FIG. 1 shows one embodiment of an electronic, centralized margin management computerized communications system 100 through which all communications flow, and remote computerized systems operated by various authorized users of each counterparty to each margin agreement. In general, where the margin agreement is a derivative agreement, the parties involved tend to be financial and investment organizations such as shown in FIG. 1, wherein the various parties are shown as financial institution organizations, such as indicated at 102 and 104, and investment group organizations, such as indicated at 106 and 108. It should be evident that the organizations involved can be any parties to a margin agreement for which communications need to be managed and controlled through a centralized communications system. Each organization 102, 104, 106 and 108 may include multiple legal entities such as indicated at 110 and 112, wherein in the example described herein the counterparties to each agreement include at least one legal entity from a financial institution and one legal entity of an investment group organization. As indicated there may be multiple agreements between legal entities of one organization and legal entities of another organization, and each agreement may be different, involve different legal entities, and/or provide for different types of securities posted as collateral. In general, the agreement must involve at least two different legal entities. Those legal entities may belong to the same or different financial institutions or investment groups. It is possible for a fund at a broker-dealer to make a margin call/recall/substitution on another fund at the same company.

System 100 requires each organization 102, 104, 106 and 108 to identify an administrator, two of which are shown 114 and 116. Each administrator communicates with the system 100 through a remote computerized system so as manage the use of the centralized system 100 on behalf of the corresponding organization and its legal entities so that centralized communications system 100 will only recognize communications from those users who are authorized to communicate through the system. Communications can also be further restricted in order to define the scope of authority of each authorized user as to what actions the users can take in connection with each designated agreement on behalf of his/her organization/legal entities. The administrator is thus essentially the system security super-user for his/her organization. The administrator 114, 116 is thus assigned by the organization to identify who within that organization is authorized to be an authorized user, as indicated for example at 118 and 120, which agreements he/she has authority to act upon, and any restrictions on the user regarding that authority. Communications regarding a margin agreement are each sent by a remote authorized user representing a party to the agreement over a wide area network, such as the internet 130, to the centralized communications system 100, and thence over the internet 130 to another remote authorized user representing the other party to the agreement. In this configuration, control over communications through the centralized communications system 100 is individually controlled by each of the remote administrators whose organization includes the legal entity that is a party to an agreement.

While the illustrated embodiment is shown as allowing only those authorized users representing selected authorized legal entities under an umbrella organization to communicate to and through the centralized margin management system, it should be noted that other arrangements are possible. For example, an organization may also be the legal entity and a party to an agreement. Centralized margin management system 100 assigns system wide, universally unique IDs (UUID) to represent the legal entities and the margin agreements when they are alleged (registered) with the centralized communications system 100. As described above, administrators 114 and 116 each may assign various rights to each of authorized users 118 and 120 for each particular agreement. For example, an administrator may assign read-only rights to an authorized user to one particular agreement and all available rights to a second agreement while assigning no rights at all to a third agreement.

Each authorized user must belong to or be associated with an organization. Administrators can “create” (i.e. appoint), delete and manage the authorized users of the centralized communications system 100 within their organization. Each authorized user may have varying degrees of visibility to the legal entities within his/her organization. An administrator can give an authorized user the right to see or access information relating to agreements to which the one or more legal entities of the organization are a party. The administrator of an organization may not grant rights to an authorized user outside of his or her own organization.

Administrators may also register, delete, and manage the legal entities. For example, an administrator for an Investment Management Firm can create a legal entity (a mutual fund) named The XYZ Short-Term Bond Fund. The XYZ Short-Term Bond Fund is a legal entity which may be a party to a margin agreement.

The administrator also has the capability to change passwords for each authorized user within his/her organization. Authorized users are required to change their password after they have been assigned a new temporary password.

Administrators also have the ability to limit the visibility of each legal entity within their organization to other organizations and legal entities. For example, if a Legal Entity ‘A’ of Organization ‘A’ is a buy side fund, and they have margin arrangements with only one other Legal Entity ‘B’ of Organization ‘B’, then the administrator for Organization ‘A’ can register the Legal Entity ‘A’ as only being visible to Legal Entity ‘B’. This provides security protections against potentially harmful and unauthorized access to proprietary information of Organization ‘A’ that is not required by the authorized users of Legal Entity B (appointed by the administrator of Organization ‘B’) to perform their functions. Likewise, the available information can be broad in scope. For example, if an administrator for a broker-dealer investment organization has a legal Entity ‘C’ which the organization wants everyone to have access to, then the administrator for organization ‘C’ can allow all legal entities to view legal entity ‘C’.

As each administrator is assigned by an organization, that person must have a company email address that is also registered with the centralized system 100. Once at least two administrators are registered, e.g. administrator 114 and administrator 116, the administrators and any authorized users appointed by those administrators each can allege a margin agreement with the other.

The centralized system 100 is compatible with a plurality of users (e.g., individuals, corporations, financial institution, margin management systems, trade management systems, etc.). The centralized system can be configured to notify the administrators and authorized users of new or modified margin management activity affecting their organizations and/or legal entities. As described in more detail below, the centralized system 100 provides workflow management for accepting, rejecting, modifying, or canceling a margin management action, with workflow between any two authorized users of any two organizations controlled and managed by the administrators of those organizations. The system 100 also provides workflow management for creating, accepting or rejecting a pledge.

The typical parties to a margin agreement requiring margin management are related as follows. Usually, a legal entity 112 of an investment or trading group organization 106 (“buy side”) enters into a margin agreement with a legal entity 112 of a financial institution organization 102 (“sell side”), such as a broker-dealer, in order to mitigate against a particular exposure to risk. For example, a party may enter into a margin agreement to swap a fixed rate financial instrument for a variable-rate financial instrument. Upon execution of the agreement, presumably the two financial instruments are of equal value.

Thereafter, in the given example, adjustments are made to the collateral held by custodian, if, on any given day, the variable rate drops (or rises) below (or above) the fixed-rate. Thus, a party may request additional collateral to protect itself, or recall collateral no longer needed to protect the other.

A custodian can be any institution, such as the Depository Trust & Clearing Corporation (“DTCC”), authorized to hold collateralized assets. While collateral may simply be cash on deposit at a bank, it is often in the form of securities. Although two parties may have entered into numerous CSAs with each other, they may choose to use only one custodial account for each of them to reduce costs. The CSA typically governs the types of securities which may be pledged as collateral. It should be noted that while the embodiment of the centralized system 100 described does not monitor and maintain records of the actual transfer of assets among the various accounts, the system can be modified to do so.

The parties interfacing with one another typically communicate using computers over local area networks (LANs), and wide area networks (WANs) such as the internet. All communications should be through secure connections, such as a virtual private network (VPN). Of importance, all communications go through the centralized system 100, where the communications can be stored and retrieved if necessary. In this way, the centralized system 100 facilitates the processing of margin calls and other margin management actions, including pledging, recalling, substituting, and interest statement requests. Further, keeping a time stamped, historical archive of all communications relating to each margin agreement facilitates an audit, should the need arise.

The system is configured to timestamp every message as it is received by a central server. Every message is guaranteed to be delivered to the receiving party once and only once. Additionally, the system guarantees that the order in which messages are delivered to the receiving party is the same order in which they are received from the sending party. Further, the central server adds a version number to all messages that can be updated, and sent or received more than once to ensure that the receiving party responds to the most current version. For example, if a margin call pledge (described more fully below) is rejected and amended, the second pledge would have a different version number than the original.

Some messages are asynchronous and outside the workflows. These messages maybe called at any time by either party to one of the workflows. For example, a party to a registered margin call may make a status inquiry, in the form of a message, to the central system for the current status of that margin call, identified by the party by providing the UUID (Universally Unique Identification) associated with the margin call.

A workflow is a given set of predefined states, as described below, through which the workflow progresses to its eventual end by the sending and receiving of predefined message types.

Each message contains a set of predefined data that is comprised of mandatory data fields and optional data fields. Only messages with at least the mandatory data fields, also called content, will be accepted by the central server as a valid message. Additionally the central server determines the current state of the workflow and is thus able to determine what message is valid, not only in content, but also in type, to move to the next valid state in the workflow. Messages received by the central server that have the incorrect content, are invalid for the current state of the workflow, or address an invalid version are responded to with an error message stating what is invalid about the incoming message.

In various embodiments of the margin management system disclosed herein, the parties to an agreement can register their agreement with the centralized system 100. One counterparty provides information to the centralized system such as the agreement type (e.g. ISDA), name of the master agreement, the names of the parties and their representatives, and the short name of the agreement according to the party's local nomenclature. Once submitted, a record of the transaction is created, and the centralized system creates a message containing the details, including the time stamp, of the transaction which is sent to the identified counterparty. In this regard, it is required that the counterparty be registered with the centralized communications system, i.e., has designated an administrator, who in turn is provided the contact information for the organization's legal entities and authorized users. The system also asks this counterparty to enter its short name of the agreement under its local nomenclature so that the file is complete. The centralized server thus has a record for each agreement including the names of the counterparties, their representatives, the name of the master agreement, and each party's local short names under their respective local nomenclatures.

Preferably the centralized system is configured and arranged so as to interface with each authorized user so that information regarding an alleged agreement can be entered, and subsequently so that an authorized user can interface with the system 100 through either one or two portals, i.e., an agreement portal and a messaging portal. The first relates more to tracking agreements between parties, while the second relates more to operations between parties based on an underlying agreement. These portals and their functionality are discussed in turn.

Agreement Portal

When an organization becomes a registered user of the centralized system 100, the system is configured to set up an account for each organization 102, 104, 106 or 108, including any of its legal entities 118, 120, as well as the administrator 114, 116 identified by the organization to represent the organization in that role. The central system 100 is configured to control all security settings set by an administrator for its organization, legal entities and authorized users including use parameters, access control, and the identify of other organizations, legal entities and margin agreements (i.e., the counterparties and other identifying information) the system will need in order for the authorized users of the organization to communicate to its counterparties in order to carry out the functions of monitoring and requesting and/or taking action in connection with any margin agreements.

Once an organization account is created, an administrator for that organization can create legal entity accounts for the legal entities within the organization to access the centralized system 100. The administrator can identify the authorized users, as well as which of its legal entities each of its authorized user can represent. Each administrator can also identify and limit which counterparties each of its authorized users may see and with which each authorized user may interact. For example, an investment manager that manages a number of funds may wish to keep secret aspects of one or more of its funds. In such a case, other users of the centralized system 100 having access authority may see a particular fund, yet not see another fund operated by the same investment manager. Accordingly, the centralized system 100 can be configured to restrict what a user sees.

Once these parties are identified, an administrator or authorized user can create a record corresponding to an agreement, by entering data in the (graphical user) interfaces shown in FIG. 23. The agreement identified at 202 may be a margin agreement, such as, for example, a standard CSA under ISDA. Such an agreement identifies the terms and parameters for managing collateral between the parties to the agreement, including parameters such as acceptable collateral, tolerances for collateral value, permissible margin variations, etc. The centralized system 100 need only store the name of the agreement, although more information about the terms of the agreement can be provided. It does not require, and there is no need for requesting, the various terms and parameters identified in the agreement. Compliance with the terms of the agreement is the responsibility of the counterparties to the agreement.

The authorized user creating the record in connection with the agreement for use in the centralized system 100 is required to identify the legal entity that the authorized user represents as indicated at 204. In some instances, the legal entity may be a organization of a number of funds, requiring the authorized user to select the specific fund as the trading party under the agreement. For example, the legal entity may be XYZ Investments, and the entities provided on a list to the authorized user may be specific XYZ Investment funds. The authorized user may also allege the legal entity that is the trading party at 206 with which trades are to made under the agreement, and the counterparty 208 to the particular agreement, if different from the trading party. For example, the ABC Brokerage House may be the counterparty, and a trading party may be ABC—London.

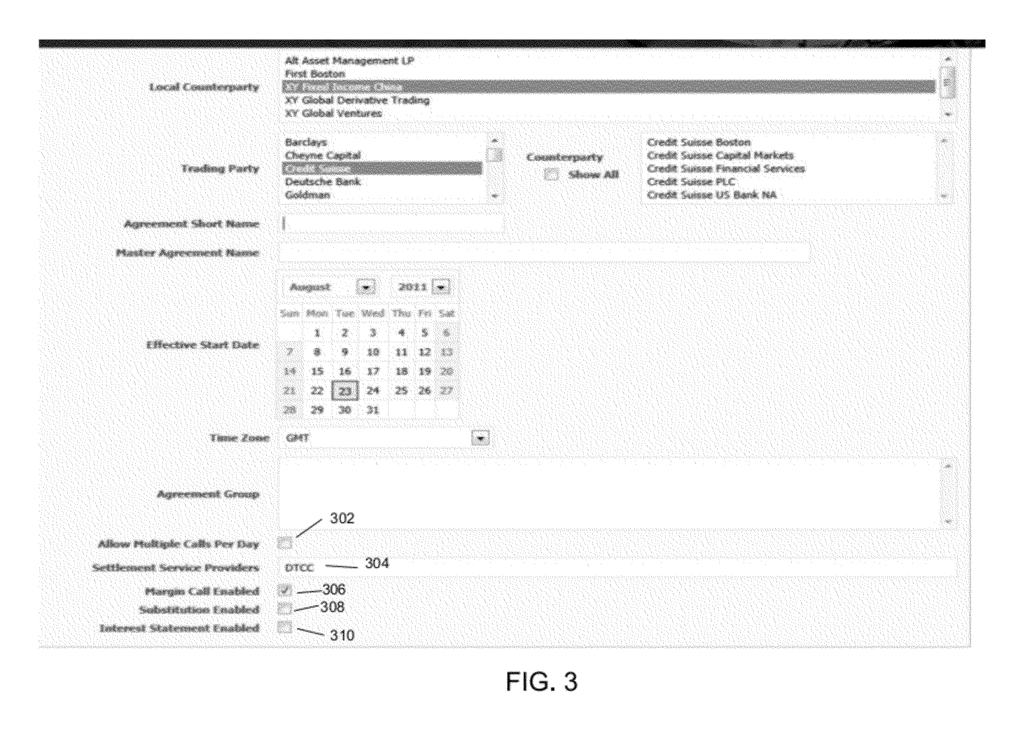

The authorized user registering the agreement then enters a local short name for the agreement and an official, legal title for the agreement at 210 and 212. This later legal title for the agreement is usually a unique identifier for the agreement that is different from that of any other agreement. Because these titles tend to be lengthy, a short name is often used within an organization to refer to the agreement. In various embodiments, the authorized user may also be asked to enter the effective date of the agreement at 214, the time zone for operating under the agreement at 216, and other parameters for the counterparties to operate under the agreement, such as whether the agreement allows for multiple calls per day, the name of the settlement provider(s), whether the agreement requires margin calls, substitution and interest statements, indicated respectively at 302, 304, 306, 308 and 310 in FIG. 3.

The creation of the record amounts to an allegation by the party creating the record that the agreement exists. Once an agreement is alleged by one party to an agreement, centralized system 100 sends an e-mail to a designated representative of the counterparty identified in the record as a counterparty, such as the counterparty's administrator, on behalf of the party making the allegation. The centralized system then sends a message (preferably an e-mail) that states that an agreement has been alleged against a member legal entity for which the administrator or other designated representative of the counterparty, is responsible. The counterparty then uses the agreement portal to acknowledge the agreement or dispute it. The counterparty also has an opportunity to provide the centralized system with its own short name or alias for the agreement identified in the allegation.

In one embodiment, the authorized user of the buy side of an agreement, such as an investment manager, enters an agreement type and identifies the sell side legal entity on the other side of the agreement, such as a broker-dealer The buy side legal entity identifies the full legal title of the margin agreement, as well as the buy side legal entity's local alias for that agreement. Once at least this information is entered, centralized system 100 will send to the authorized user of the sell side legal entity an e-mail on behalf of the buy side legal entity, alleging that a margin agreement exists between the parties. The authorized user of the sell side legal entity then verifies the accuracy of the data in the allegation, including the full legal title of the margin agreement, and accepts the allegation if appropriate. Once this process terminates, the parties may then make margin calls in accordance with the margin agreement using the centralized system 100 through which all communications can flow.

The centralized system 100 can thus be used by a party to manage all of its agreements and operations under those agreements. All communications flowing through system 100 can also be archived in secure data storage memory (not shown) to enable reconstruction of all communications relating to an agreement, facilitating audits should that be necessary.

Agreement Portal

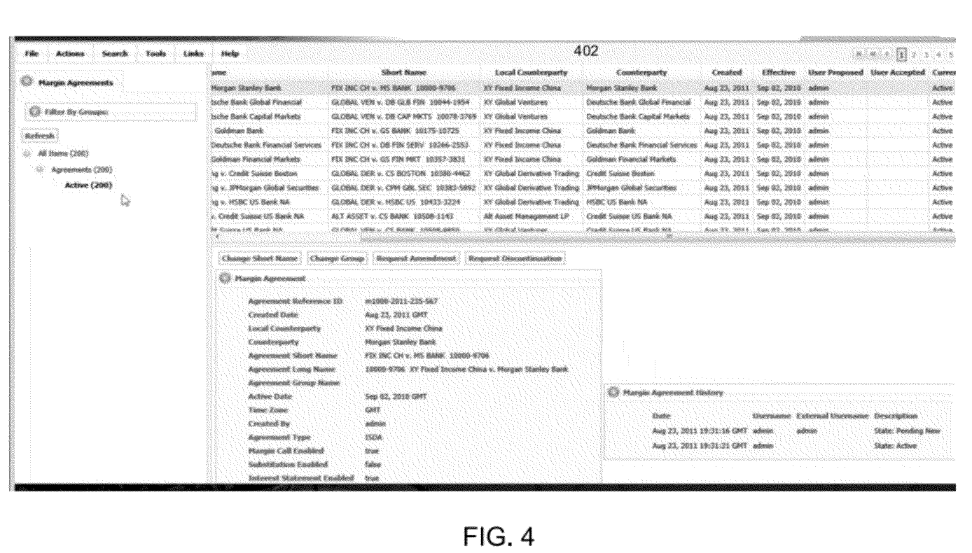

As shown in FIGS. 4, an authorized user may enter the centralized system 100 to view all of the active agreements which he or she is authorized to access. The user may sort the agreements by various fields, as shown at the top of the table 402 in FIG. 4, e.g., the counterparty, the short name of the agreement, the local counterparty (the legal entity on their own side), the counterparty, date created etc. The table or a separate table may also identify any pending agreements, i.e., agreements that have been alleged but not confirmed. Accordingly, the current status may also be indicated for each agreement in the table. The authorized user may also amend the short name in the system. The user may also send a request for amendment or discontinuation of an agreement to a counterparty.

In various embodiments, an organization or legal entity may wish to delegate its duties under an agreement to a third party administrator (“TPA”). For example, Company A is on the buy side of an agreement, and Company B is on the sell side. Company A may outsource its duties under an agreement to a TPA. Centralized system 100 will permit an administrator to designate a TPA for receiving various calls or other work flows associated with a given agreement. The authority given to the TPA to accept, reject, pledge, or otherwise make decisions in a work flow can be configured so that in various circumstances an administrator or other user at the organization must approve a TPA's actions.

The centralized system 100 is configured so as to assign and use unique legal entity identifiers that are assigned to various legal entries recognized by the centralized system. When an agreement, such as a CSA, is registered, the agreement is assigned a unique agreement identifier, along with the unique entity identifiers associated with the legal entities that are parties to that agreement, and the contact information, i.e., relevant e-mail addresses of the authorized users responsible for that agreement. Similarly, when a workflow action is triggered, such as a margin call, a unique work flow action identifier is assigned to that action, and linked to the other unique identifiers. Thus, when a workflow action is initiated by an authorized user and received by the centralized system, the centralized system will know the identity of the agreement to which the message relates and to whom to forward the action (e-mail) message. Since each work flow action message contains the relevant identifications of parties and authorized users, and can be archived in the centralized system, an authorized user having access to the file may review the history of all work flow action requests for any given margin agreement.

Messaging Portal

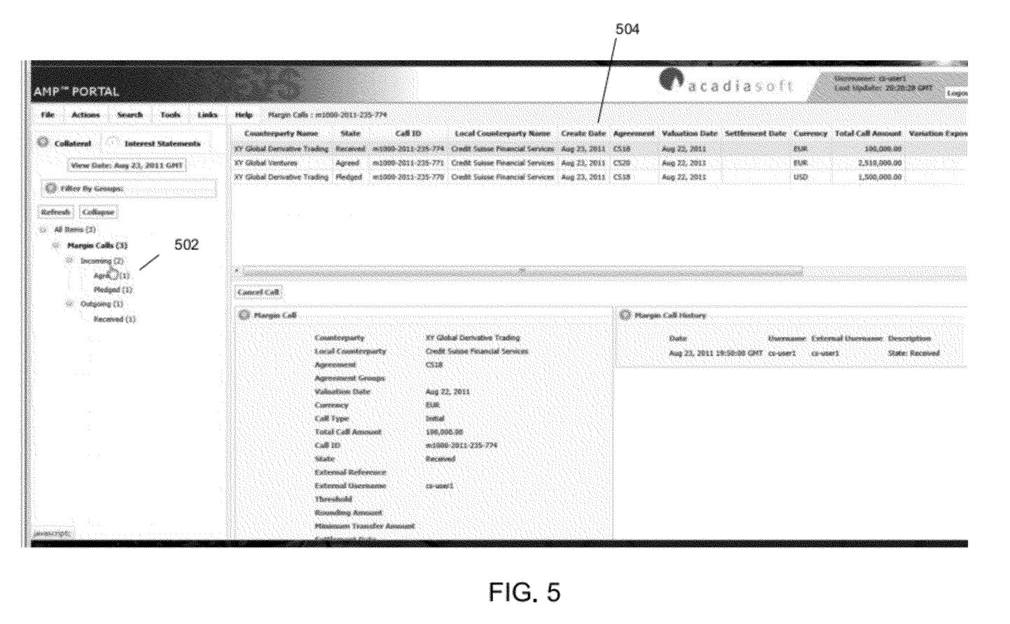

As shown in FIG. 5, an authorized user may select an agreement and review each request that has occurred under the agreement. The authorized user may review all incoming and outgoing requests associated with a particular margin agreement, as well as the status of each request as indicated at 502. Again, the authorized user may sort these listing by any of the fields at the top of the table 504 shown in FIG. 5.

In one embodiment, the centralized system 100 is integrated with each legal entity's local margin management system. In this instance, when an authorized user representing the client requests a workflow action, the authorized user need only make the request based on the legal entity's local alias for the subject agreement. The system 100 will then match the local alias to the unique legal entity ID for the subject agreement corresponding to the local alias when sending the workflow action request through system 100.

Similarly, because these identifiers are included within all workflow action requests corresponding to a particular agreement, a party can monitor actions after the workflow action has terminated. For example, suppose a margin call has been made and accepted and is followed by a pledge of a change in collateral held in the custodial account. A legal entity may have, on any given day, several pledged amounts coming into or leaving a custodial account. Further, the process of fulfilling a pledge also takes time. By tracking each change in collateral authorized users are unable to easily determine the amount of collateral associated with a given agreement at any given time. The use of unique identifiers by the centralized system, however, permits an authorized user to monitor each movement of collateral for each margin agreement, not based on the totality of assets in an account.

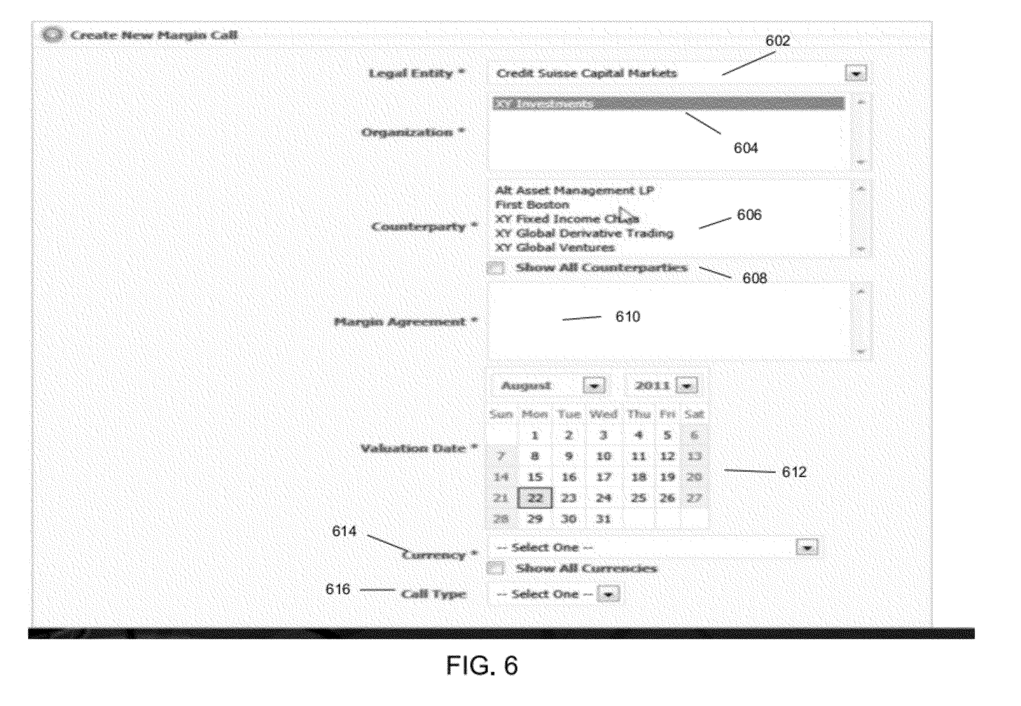

An authorized user of the centralized system may create a workflow request, as shown in each of FIGS. 11-14. Workflows that are available include margin calls, recalls, substitution, and expected margin calls. As described, a “margin call” is a request for additional collateral. A “recall” is a request for the return of collateral. “Substitution” is a request for the substitution of one type of collateral for another. “Expected margin” calls are calls stating that the authorized user is expecting a margin call from a counterparty. The centralized system 100 will automatically match an incoming margin call under an identified agreement with an expected margin call made for the same agreement. The centralized system 100 can be configured to calculate whether the expected margin call and the margin call are for amounts within a certain tolerance, i.e., a margin variation. If so, system 100 can be configured to accept and/or pledge the amount in the margin call. The counterparty making a margin call is not informed of the party's expected margin call. In the exemplary implementation shown in FIGS. 6-9, an authorized user enters the name of its legal entity, the counterparty organization, and the legal entity within the counterparty organization that is a party to the margin agreement. The party also enters its local alias for the subject agreement. The party also requests a particular work flow type to create the work flow request.

The following descriptions relate to specific work flow requests:

Specific Margin Management Actions

FIG. 6 shows the interface for an authorized user to create a new margin call. The names of the legal entity and organization making the call are entered at 602 and 604. The counterparty and margin agreement, with the option of indicating all of the counterparties if more than one, are also indicated at 606 and 608. The name of the margin agreement, the valuation date and type of margin call are also indicated at 610 and 612. A call type can also be indicated at 614.

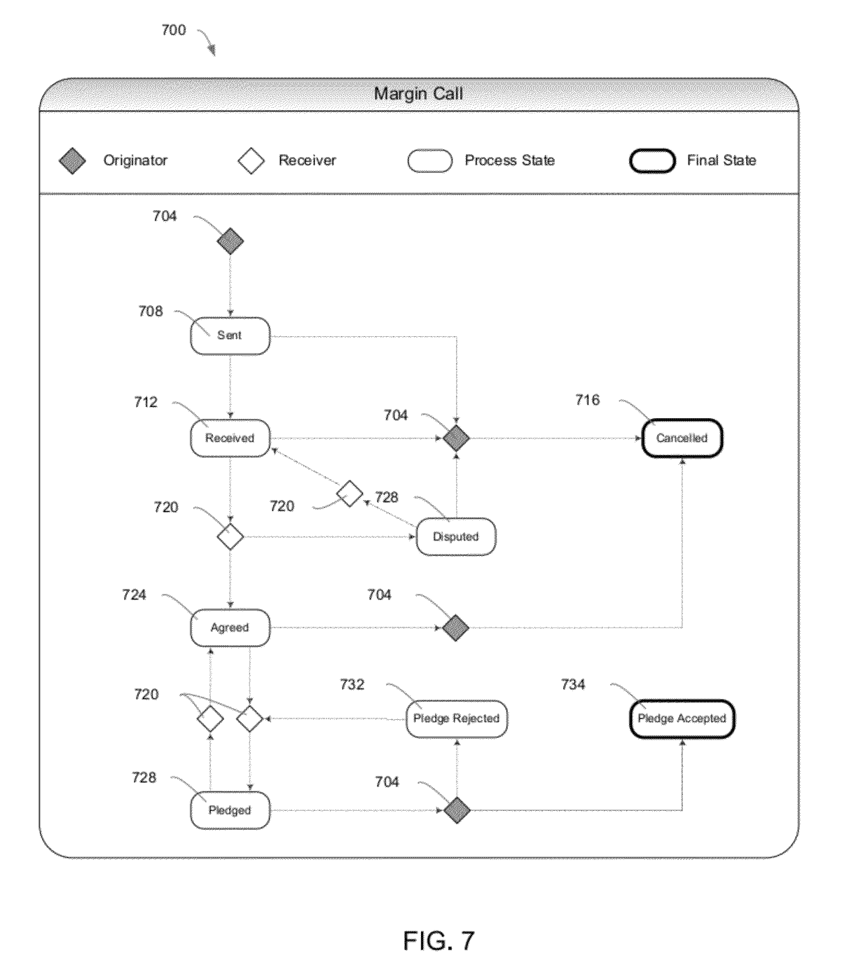

FIG. 7 shows a flow chart/state diagram for the making of a margin call with respect to a given margin agreement in accordance with this various embodiments disclosed herein. Each day, an authorized user can calculate or have calculated the value of the financial instrument(s) currently held in the appropriate custodial account, and the amount of its exposure or the counterparty's exposure using market indicators from the close of the previous business day. It then calculates the value of the assets, if any, currently held in the custodial account as collateral under the margin agreement. If the counterparty is undercollateralized, then the originator (requestor) 704 originates a margin call. It sends a request 708 for additional collateral against the margin agreement. The request identifies the sending party's short name for the agreement, the valuation dates used in calculating the amount of collateral requested, the currency used, and the final transfer amount. At nearly any time in the process, the originator 704 can cancel 716 the margin call. While a cancelled margin call cannot be revived, a new margin call can be commenced in its place.

At centralized system 100, the short name in the margin call is transformed into the short name used by the authorized user of the request receiver (authorized user of the counterparty) 720, designated to receive the request. The transformation of short names occurs between any transmission of correspondence. This transformation permits the seamless interface of the margin call procedure into various investment groups' or banks' systems through the use of local naming systems. All margin calls and communications related thereto, thus, are described in terms of the authorized users and their legal entities and organizations viewing the communication.

The margin call is then received 712 by the receiver 720, who is the designated authorized user of the counterparty to the margin agreement. The receiver 720 may either agree 724 to the call or dispute 728 the amount of additional collateral requested. In the former case, the receiver acknowledges that at least some collateral is due. The receiver 720 may agree to pay the full amount requested or may agree to pay an amount less than the requested amount. If the receiver 720 agrees to pledge 728 the full amount, then the originator 704 can reject 732 that pledge or accept 734 it. If the pledge is accepted 734, then the receiver can instruct its custodian to transfer the agreed amount into the FBO account of the custodial account for the receiver. If the receiver 720 agrees to pledge 728 only a partial amount of that requested, then the receiver 704 can accept 734 the agreed amount. If the receiver 720 disputes any (or all) of the requested amount, then the amount-in-dispute is returned to originator 704.

As mentioned above, the centralized system 100 assigns a unique identifier to any request by requestor 704, such as a margin call, substitution request, recall, or interest statement request. A unique identifier is also assigned to subsequent processing and transactions, such as the recipient's agreed amount 724 or disputed amount 728. This unique identifier is a proprietary formatted Universally Unique ID for easily locating prior transactions in performing the margin agreement.

In various embodiments, the settlement instructions to the custodian require that the custodian provide the unique identifier for the agreed amount with the transfer of collateral. The custodian can obtain the unique identifier from either the centralized system or the instructing party. If the parties “pool” their collateral into one set of custodial accounts, then the parties can easily resolve any discrepancies in the total collateral in the accounts. For example, suppose collateral is owed on two agreements in the amount of $8 M and $2 M, respectively, but only $9 M in cash is in the account. The parties can reference the unique identifier for the agreed amounts and determine which agreement(s) is(are) undercollateralized.

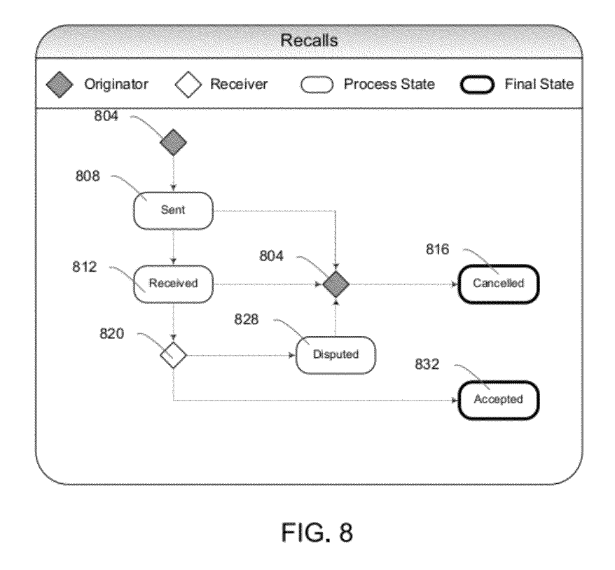

This disclosure contemplates other types of margin management actions. In one embodiment, in the event of overcollateralization, a party can “recall” an amount of excess collateral, as shown in FIG. 8. The originator 804 sends a recall request for an amount with respect to a margin agreement identified by the originator's local nomenclature. The recall request identifies the party's short name for the agreement, the valuation dates used in calculating the amount of collateral to be recalled, the settlement date when the collateral is expected to be returned, and the outgoing line item for the recall. The centralized system 100 transforms the request to identify the agreement according to the recipient's nomenclature. The transformed request is received 812 by the receiver 820. The receiver 820 can either dispute 828, or partially or fully accept 832 the request to recall collateral. If accepted 832, then the receiver 820 will instruct the custodian to return the agreed amount to the originator 804. In certain embodiments, this instruction may also request the custodian to include a unique identifier associated with the agreed amount when performing the settlement.

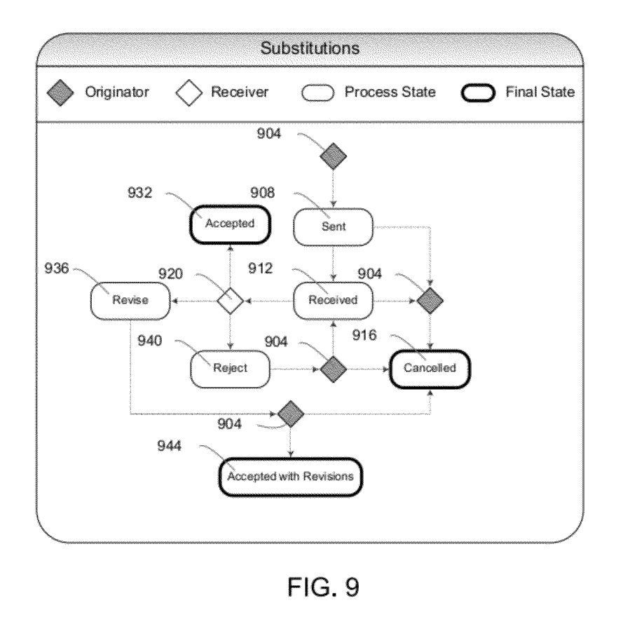

Another embodiment contemplates a “substitution” request, as shown in FIG. 9. Substitution is requested when one party wants to swap collateral. For example, suppose stock that is owned by the party is sold after it is posted as collateral. The originator 904 may then request that another form of collateral be substituted instead. The substitution request identifies the originator's 904 short name for the agreement, the valuation dates used in calculating the amount of collateral to be substituted, the settlement date when the collateral is expected to be returned, and outgoing and incoming line items for the substitution. It sends 908 the request to a centralized system 100, where the request is linked to identification information of the subject agreement according to the receiver's 920 local nomenclature. Once received 912, the receiver 920 can either accept 932, revise 936, or reject 940 the request. If a revision 936 is proposed, then the receiver 904 can accept the revisions 944.

Yet another embodiment contemplates a request for an “interest statement” when cash is held as collateral. Because collateral held in a counterparty's custodial account is owned by the collateralizing party, the collateralizing party may request from the counterparty the interest accrued on its cash held in the custodial account as collateral.

Because the centralized system 100 monitors all of the margin management activity and assigns unique identifiers to each action, it can provide to a party all records for a certain agreement or for a certain day or other time period. In one embodiment, the centralized system 100 can provide such information in the form of a spreadsheet sorted by agreement identifying each valuation date, currency, final transfer amount, disputed amount, pledged collateral, or other data. In other embodiments, a party can view all of its transactions through the message portal to review all outgoing (originator 704, 804, 904) and incoming (receiver 720, 820, 920) messages and their status in a mailbox-type format.

A party can communicate with the centralized system using a computer. The computer is adapted to be connected to the centralized system 100 over a wide area network, such as the internet. The party can interface with the centralized system 100 through an application programming interface (“API”) or other software, which includes the agreement and message portals. The centralized system 100 can be one or more servers maintaining the database of information of the parties' agreements and margin management activity.

Those of skill in the art would appreciate that the various illustrative blocks, modules, elements, components, methods, and algorithms described herein may be implemented as electronic hardware, computer software, or combinations of both. For example, the electronic, centralized margin management system may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configuration of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. Furthermore, to the extent that the term “include,” “have,” or the like is used in the description or the claims, such term is intended to be inclusive in a manner similar to the term “comprise” as “comprise” is interpreted when employed as a transitional word in a claim.

Various modifications may be made to the examples described in the foregoing, and any related teachings may be applied in numerous applications, only some of which have been described herein. It is intended by the following claims to claim any and all applications, modifications and variations that fall within the true scope of the present teachings.

What is claimed is:

1. A communication system for storing records of details of margin agreements registered with the communication system and facilitating the processing of a recall of collateral requested from one authorized computer of one party to a registered margin agreement and identified as the request originator, over a wide area network to another authorized computer of the counterparty to the registered margin agreement and identified as the request receiver, the system comprising:
at least one intermediate computerized system connected so as to send and receive communications over the wide area network to each authorized computer, the intermediate computerized system being configured and arranged so as to (a) receive, from an authorized computer associated with the request originator, a request for recall of collateral established in an account under a registered margin agreement, the recall request comprising recall information, including identification of the margin agreement and the amount of the requested recall; (b) forward a notification of the recall request over the wide area network to an authorized computer associated with the request receiver identified as a counterparty to the registered margin agreement; (c) receive a response from the request receiver including whether it agrees or disputes the recall; and (d) forward the response from the request receiver to the request originator.

2. The communication system of claim 1, wherein the intermediate computerized system is also connected to an authorized computer of the custodian of the account, and is further configured and arranged so as to forward instructions to the custodian to return the amount of collateral when the response form the receiver indicates agreement with the amount of the requested recall.

3. The communication system of claim 2, wherein the intermediate computerized system includes data storage configured and arranged so as to store a unique identifier associated with the agreement when performing the return of the amount of collateral.

4. The communication system of claim 1, wherein the intermediate computerized system includes data storage configured and arranged so as to register information with respect to each registered margin agreement, including a unique name for the margin agreement and the short name given to the registered margin agreement by each counterparty.

5. The communication system of claim 4, wherein the registered information stored in data storage further includes electronic contact information for each counterparty to the registered margin agreement so that communications are automatically forwarded to a receiving party upon identification of the margin agreement by the sender of each communication.

6. The communication system of claim 1, wherein the recall request includes the valuation date or dates used in calculating the amount of the collateral recall, the settlement date by which the amount of the collateral recall is expected to be returned, and the outgoing line item of the recall request.

7. The communication system of claim 6, wherein the intermediate computerized system is further configured and arranged so as to forward a response from the request originator to the request receiver and indicating a partial or complete acceptance or a rejection of the pledged amount.

8. The communication system of claim 7, wherein the intermediate computerized system is further configured and arranged so as to forward a request from the request originator to the request receiver to transfer the agreed upon amount upon acceptance of that amount by the request originator.

9. The communication system of claim 7, wherein the intermediate computerized system is further configured and arranged so as to forward a recall request from the request originator to a custodian to transfer the agreed amount upon acceptance of that amount by the request originator.

10. The communication system of claim 1, wherein the intermediate computerized system is further configured and arranged so as to assign a unique identifier to each request for each recall.

11. The communication system of claim 10, wherein the intermediate computerized system is further configured and arranged so as to assign a unique identifier to each of the subsequent responses to the recall request.

12. The communication system according to claim 1, wherein the intermediate computerized system is configured and arranged to provide a portal at which each counterparty can generate its request and response relating to the recall.

13. A communication system according to claim 1, wherein the communications are in the form of messages and the intermediate computerized communication system is further configured and arranged so as to timestamp messages when they are received and forward those messages in the order in which they are received.

14. A communication system according to claim 1, wherein the communications are in the form of messages and the intermediate computerized communication system is further configured and arranged so as to assign consecutive version numbers to all messages that are updated by an authorized user and that can be forwarded more than once so that the receiving party can respond to the most current version of that message.

15. A communication system according to claim 1, wherein the communications are in the form of messages and the intermediate computerized communication system is further configured and arranged so that some messages can be asynchronous, outside workflows of the system, and stored so that they can be accessed at anytime by an authorized user.

16. A communication system according to claim 1, wherein the communications are in the form of messages and the intermediate computerized communication system is further configured and arranged so that messages are processed as workflow defined by a given set of predefined states.

17. A communication system according to claim 16, wherein the intermediate computerized communication system is further configured and arranged so that the workflow progresses to an eventual end by sending and receiving messages in the form of predefined message types.

18. A communication system according to claim 1, wherein the communications are in the form of messages and the intermediate computerized communication system is further configured and arranged so that each message includes a set of predefined data comprising data fields.

19. A communication system according to claim 18, wherein at least some of the data fields are mandatory and at least some of the data fields are optional.

20. A communication system according to claim 19, wherein the intermediate computerized communication system is further configured and arranged so that the intermediate computerized communication system will only accept messages as valid if they include at least information in the mandatory data fields.

21. A communication system according to claim 1, wherein the communications are in the form of messages, messages are processed as workflow defined by a given set of predefined states, and the intermediate computerized communication system is further configured and arranged so as to check the current state of the workflow and determine whether a current message is valid in content and type before proceeding to the next valid state of the workflow.

22. A communication system according to claim 21, wherein the intermediate computerized communication system is further configured and arranged so as that (a) messages received by the intermediate computerized communication system are treated as invalid if a message has incorrect content for the current state of workflow, or addresses an invalid version, and (b) an error message is generated to the authorized user sending the message stating why the incoming message is invalid.

23. A communication system according to claim 1, wherein the intermediate computerized communication system is further configured and arranged so as to provide a portal at which each counterparty can generate its request and response relating to the margin call.

24. A method of facilitating the processing of a recall of collateral requested from one authorized computer of one party to a margin agreement registered on a intermediate computerized system, and identified as the request originator, over a wide area network to another authorized computer of the counterparty to the registered margin agreement identified as the request receiver, the method comprising:
at the intermediate computerized system performing the following steps:
sending and receiving communications over the wide area network to each authorized computer, including:
(a) receiving from an authorized computer associated with the request originator, a request for recall of collateral under a registered margin agreement, the recall request comprising recall information including identification of the margin agreement, and the amount of the requested collateral being recalled,
(b) forwarding a notification of the recall request over the wide area network to an authorized computer associated with the request receiver identified as a counterparty to the registered margin agreement;
(c) receiving a response from the request receiver including whether it agrees or disputes the recall; and
(d) forwarding the response from the request receiver to the request originator.

25. The method of claim 24, wherein sending and receiving communications further includes forwarding instructions to an authorized computer of the custodian of the account to return the amount of collateral when the response from the receiver indicates agreement with the amount of the requested recall.

26. The method of claim 24, further including storing registered information on the intermediate computerized system with respect to each registered margin agreement including a unique name for the margin agreement, and the short name given to the registered margin agreement by each counterparty so as to facilitate communications regarding the margin call requests.

27. The method of claim 24, wherein the step of storing registration information includes storing electronic contact information for each counterparty to the registered margin agreement so that communications are automatically forwarded to a receiving party upon identification of the margin agreement by the sender of each communication.

28. The method of claim 24, wherein the step of forwarding includes an agreement to recall an amount of collateral equal to the full or a portion of the amount of collateral of the recall requested.

29. The method of claim 24, further including the step of forwarding a response from the request originator to the request receiver indicating a partial or complete acceptance or a rejection of the amount of collateral contained in the recall request.

30. The method of claim 29, further including forwarding a request from the request originator to a custodian to transfer the agreed collateral upon acceptance of that amount of the recall by the request originator.

31. The method of claim 24, further including assigning a unique identifier to each request for each recall.

32. The method of claim 31, further including assigning a version number to each of the subsequent responses to the recall request.

33. The method according to claim 24, further including providing a portal at which each counterparty can generate its request and response relating to the recall request.

34. A method according to claim 24, wherein the communications are in the form of messages, further including time stamping messages when they are received and forwarding those messages in the order in which they are received.

35. A method according to claim 24, further including assigning consecutive version numbers to all messages that are updated by an authorized user and that can be forwarded more than once so that the receiving party can respond to the most current version of that message.

36. A method according to claim 24, wherein communications including messages that are in the form of asynchronous messages, outside workflows of the system, further including storing the asynchronous messages so that they can be accessed at any time by an authorized user.

37. A method according to claim 24, wherein the communications are in the form of messages, and further including processing messages as workflow defined by a given set of predefined states.

38. A method according to claim 37, wherein processing messages as workflow includes processing the messages to an eventual end by sending and receiving messages in the form of predefined message types.

39. A method according to claim 24, wherein each message includes a set of predefined data comprising data fields.

40. A method according to claim 39, wherein at least some of the data fields are mandatory and at least some of the data fields are optional.

41. A method according to claim 40, wherein messages will only be accepted as valid if they include at least information in the mandatory data fields.

42. A method according to claim 24, wherein the communications are in the form of messages, further including processing messages as workflow defined by a given set of predefined states, and checking the current state of the workflow, and determining whether a current message is valid in content and type before proceeding to the next valid state of the workflow.

43. A method according to claim 42, wherein (a) treating as invalid messages received by the central computerized communications system that have incorrect content for the current state of workflow, or address an invalid version, and (b) generating an error message to the authorized user sending the message stating why the incoming message is invalid.
